(19) United States
(12) Patent Application Publication
(10) Pub. No.: US 2020/0031727 A1
(43) Pub. Date: Jan. 30, 2020

(54) METHOD FOR PRODUCING A POROUS CERAMIC BODY AND THE POROUS CERAMIC BODY OBTAINED

(71) Applicant: CEMBRANE A/S, Lynge (DK)

(72) Inventor: Niklas ANDREASSEN, Græsted (DK)

(73) Assignee: CEMBRANE A/S, Lynge (DK)

(21) Appl. No.: 16/483,985

(22) PCT Filed: Feb. 6, 2018
(86) PCT No.: PCT/EP2018/052866

§ 371 Date: Aug. 6, 2019

(30) Foreign Application Priority Data
Feb. 7, 2017 (DK) PA 2017 00079

(51) Int. Cl. C04B 41/87; C04B 41/50; C04B 41/00; B01D 71/02; B01D 67/00

(52) U.S. Cl. CPC C04B 41/87; C04B 41/5059; C04B 2111/00801; B01D 71/024; B01D 67/0041; C04B 41/009

(57) ABSTRACT

The present invention relates to a method for the production of a porous ceramic body, the method comprises the following steps: (i) selecting a ceramic powder; (ii) selecting a binder comprising a pre-ceramic polymer; (iii) mixing the ceramic powder from step (i) with the binder from step (ii) providing a ceramic composition; (iv) coating a porous support with the ceramic composition providing a ceramic coated porous support; (v) heating the ceramic coated porous support to a temperature between 500° C.-1500° C. producing the porous ceramic body.

### TECHNICAL FIELD OF THE INVENTION

The present invention relates to a method for producing a porous ceramic body and the porous ceramic body as such. Preferably, the present invention relates to a method for producing a porous ceramic body using low temperatures during heating of the porous ceramic body. The porous ceramic body may preferably be used as a filter, in particular an outside-in filter.

### BACKGROUND OF THE INVENTION

Porous ceramic bodies, such as membrane filters, have been used for years in many different industries as a tool for fractionating materials in a liquid mixture. The membrane filter comprises of porous a material designed to retain some constituents (the retentate) from the liquid mixture and allowing other constituents of the liquid mixture to pass (the permeate).

The most common industrial areas where membrane filters may be chemical engineering, water purification, food technology, waste water treatment etc., wherein the constituents of a liquid stream are to be fractionated.

In addition to these industrial applications of membrane filters the world is also struggling to supply the ever-increasing demand for clean water. It is estimated that 1.1 Billion people lack access to safe drinking water and there is an increasing demand from industry and farmers to fresh water. Increased pollution and increasing stress on the world's water resources is driving the demand for new and efficient technologies such as membrane technology to provide sufficient amount of water.

Hence, water treatment will remain a top priority and membrane filters are essential in expansions and upgrades of water treatment infrastructures. Higher environmental standards and regulations in many countries around the world and high population growth, particularly in water-stressed areas, further increase the demand for water purification systems.

Depending on the size of the materials to be removed from the liquid stream, the membrane filter may be specifically designed. Here a distinction is made between microfiltration (MF), ultrafiltration (UF) and nanofiltration (NF) and reversed osmosis (RO) depending on the mean pore size, and hence the grains/constituents allowed to pass the membrane filter. The smaller the grains to be filtered out, the higher the demands imposed on the filter technology and the filter membranes used.

Membrane filters are specifically designed with a specific mean pore size depending on the specific application of the filter. When used in fractionating the constituents of a liquid mixture, constituents having a grain size larger than the pore size of the membrane filter are retained by the filter and ends up in the retentate fraction. The constituents in the liquid mixture having a grain size smaller than the pore size of the membrane filter are allowed to run through the membrane filter and ends up in the permeate fraction.

The market of porous ceramic bodies, such as membrane filters, is dominated by the well-known and low-cost polymer membranes, even though ceramic membranes are more robust chemically and mechanically, offer longer life, and provide a more stable operation. One downside to ceramic membranes is the higher price, which is only partly absorbed by the higher throughput pr. square meter membrane surface. Nonetheless, as the price of producing porous ceramic bodies comes down, the benefits are becoming more and more evident.

One example of producing porous ceramic bodies is U.S. Pat. No. 7,699,903, which describes a method for producing a porous ceramic body (a ceramic membrane) comprising silicon carbide (SiC) which involves powder mixture having a bimodal grain distribution of a first ceramic grain powder having a significantly large grain size and a second ceramic grain powder which dissolve during heating and participate in attaching the larger grains together. This process is repeated several times with decreasing grain sizes of the first ceramic grain powder to provide the final membrane.

EP 3 009 182 describes a method for the production of a porous ceramic body using a 3 modal combination of ceramic powder, such as SiC. The method comprising the following steps: selecting a first ceramic powder with a first mean grain size; selecting a second ceramic powder with a second mean grain size; selecting a third ceramic powder with a third mean grain size; mixing the first ceramic powder, the second ceramic powder and the third ceramic powder to produce a powder composition comprising at least a trimodal grain size distribution; coating a porous support with the powder composition providing a coated ceramic body; and heating the coated ceramic body to a temperature between 1550-1900° C. producing the porous ceramic body.

One of problems with the prior art methods, e.g. as described in U.S. Pat. No. 7,699,903 and EP 3 009 182 is the layer-wise repetition of applying the ceramic powder; repeatedly heating and cooling of the ceramic powders and the use of the high temperatures to provide the final porous ceramic body, which makes the process troublesome, time consuming and costly.

Hence, an improved process for providing a porous ceramic body, such as a membrane filter, would be advantageous, and in particular a more efficient and/or reliable process for providing a porous ceramic body, such as a membrane filter, which is easier, less time consuming and less costly would be advantageous.

### SUMMARY OF THE INVENTION

Thus, an object of the present invention relates to a porous ceramic body, such as a membrane filter

In particular, it is an object of the present invention to provide a more efficient and/or reliable process for providing a porous ceramic body, such as a membrane filter that solves the above mentioned problems of the prior art with, complexity of the process, time consumption and costs.

Thus, one aspect of the invention relates to a method for the production of a porous ceramic body, the method comprises the following steps:
(i) selecting a ceramic powder;
(ii) selecting a binder comprising a pre-ceramic polymer;
(iii) mixing the ceramic powder from step (i) with the binder from step (ii) providing a ceramic composition;
(iv) coating a porous support with the ceramic composition providing a ceramic coated porous support;
(v) heating the ceramic coated porous support to a temperature between 500° C.-1500° C. producing the porous ceramic body.

Another aspect of the present invention relates to a porous ceramic body comprising crystal-like ceramic grains.

Yet another aspect of the present invention relates to a porous ceramic body obtainable by a method according to the present invention.

Still another aspect of the present invention is to provide a system and a submersible system, comprising two or more porous ceramic bodies according to the present invention, or as obtainable by a method according to the present invention.

An even further aspect of the present invention relates to a composition comprising a binder, a solvent and a pore filler, wherein the binder comprises a pre-ceramic polymer.

Furthermore, an aspect of the present invention relates to the use of the porous ceramic body according to the present invention, or the porous ceramic body obtainable by a method according to the present invention, in a microfiltration or an ultrafiltration.

### BRIEF DESCRIPTION OF THE FIGURES

FIG. 1 shows a SEM picture of a porous ceramic body provided according to the prior art where the ceramic coated porous support is heated to a temperature in the range of 1550° C. to 1900° C.

FIG. 2 shows a SEM picture of a porous ceramic body provided according to the present invention where the ceramic coated porous support is heated to a temperature about 800° C.

The present invention will now be described in more detail in the following.

### DETAILED DESCRIPTION OF THE INVENTION

As mentioned above, the conventional methods for producing porous ceramic bodies, such as membrane filters, involves high costs, long production time and complex handling steps. All things which influence on the final costs of the porous ceramic bodies and which makes the porous ceramic bodies, such as the membrane filters, less competitive relative to e.g. low-cost polymer membranes and other separation processes used. The part of the process that add most of the time and costs to the final porous ceramic body is the heating and subsequent cooling of the coated ceramic coated porous support, which goes to at least 1550° C. for several hours. The inventor of the present invention surprisingly found that by providing the proper combination of ceramic powder and a binder comprising a pre-ceramic polymer, whereby the heating can be performed at temperatures below 1500° C., preferably, below 1000° C. in shorter time providing high quality porous ceramic bodies, such as membrane filters. By the present invention it has become possible to provide membrane filters having small mean pore size (such as in the ultrafiltration or microfiltration range), hence, the membrane filter according to the present invention may have a mean pore sizes above 5 nm, such as above 10 nm, e.g. above 20 nm, such as above 25 nm, e.g. above 50 nm, such as above 100 nm, e.g. above 250 nm, such as above 500 nm, e.g. above 1000 nm. Hence, By this method it has become possible to provide porous ceramic bodies, such as membrane filters having mean pore sizes useful in microfiltration or ultrafiltration, at significant reduced processing time and processing costs.

Hence, a preferred embodiment of the present invention relates to a method for the production of a porous ceramic body, the method comprises the following steps:
(i) selecting a ceramic powder;
(ii) selecting a binder comprising a pre-ceramic polymer;
(iii) mixing the ceramic powder from step (i) with the binder from step (ii) providing a ceramic composition;
(iv) coating a porous support with the ceramic composition providing a ceramic coated porous support;
(v) heating the ceramic coated porous support to a temperature between 500° C.-1500° C. producing the porous ceramic body.

In the context of the present invention, the term “porous ceramic body” relates to a porous ceramic structure where all the ceramic grains in the porous ceramic body are united into a single coherent structure.

In an embodiment of the present invention, the porous ceramic body may be a porous liquid ceramic body. In particular, the porous ceramic body, or the porous liquid ceramic body may be a porous water ceramic body.

In the context of the present invention the term “porous liquid ceramic body” relates to a porous ceramic body suitable for fractionating one or more constituents from a liquid composition, such as water.

A further preferred embodiment of the present invention relates to a method for the production of a porous ceramic body, the method comprises the following steps:
(i) selecting a ceramic powder;
(ii) selecting a binder comprising a pre-ceramic polymer;
(iii) mixing the ceramic powder from step (i) with the binder from step (ii) providing a ceramic composition;
(iv) coating a porous support with the ceramic composition providing a ceramic coated porous support;
(v) heating the ceramic coated porous support to a temperature of 1500° C. or below producing the porous ceramic body

In a further embodiment of the present invention the ceramic coated porous support may be heated to a temperature of 1500° C. or below producing the porous ceramic body, such as a temperature of 1400° C. or below, e.g. a temperature of 1300° C. or below, such as a temperature of 1200° C. or below, e.g. a temperature of 1100° C. or below, such as a temperature of 1000° C. or below, e.g. a temperature of 900° C. or below, such as a temperature of 800° C. or below.

The ceramic powder provided in step (i) may preferably be selected from the group consisting of aluminium oxide, silicon carbide, silicon dioxide, titanium, titanium oxide, zirconium, zirconium oxide and mixtures hereof. Even more preferably, the ceramic powder may be silicon, and even more preferably, the ceramic powder may be silicon carbide (SiC). The most preferred ceramic powder may be wherein the ceramic powder comprises alpha-SiC.

The porous ceramic body may relate to various forms and shapes of a porous ceramic structure. The porous ceramic element or the porous ceramic body may also be applicable in various applications wherein fractionation of at least one constituent from a liquid composition is desired. In the present invention, the liquid composition may preferably be water and even more preferably, the water may be selected from the group consisting of ground water, surface water (such as, river water, lake water, wetland water, or ocean water), produced water, process water, reverse osmosis filtrate re-mineralization and waste water; however, the porous ceramic element or the porous ceramic body may also be used for fractionating other liquid compositions.

In the present context, the term “produced water” relates to the oil industry to describe water that may be produced as a byproduct along with the oil and gas. Oil and gas reservoirs often have water as well as hydrocarbons, sometimes in a zone that lies under the hydrocarbons, and sometimes in the same zone with the oil and gas. Oil wells sometimes produce large volumes of water with the oil, while gas wells tend to produce water in smaller proportion.

Furthermore, in the present context the term “process water” relates to treated water to be fed into wide range of equipment's and devices such as boilers, heat exchangers, engines, and/or for chemicals dilution and in chemical processes. Process water should typically have a conductivity ranging from 0.1 to 50 μS/cm, with little to no hardness to avoid scaling in heating system. Oxygen and carbon dioxide should be removed to prevent corrosion. Tap water or fresh groundwater are the most widely used source of water to produce process water.

In an embodiment of the present invention, waste water may be obtained from metal processing, electronic industry, textile production, laundry, the oil industry, the chemical industry, sewage or the food industry.

Since, water purification processes like this relates to enormous volumes it is desirable to have a system which is chemically and mechanically stable and at the same time which is cheaper, faster and simpler to produce compared to traditionally produced porous ceramic bodies.

In an embodiment of the present invention the pre-ceramic polymer comprises an organic molecular segment and an inorganic segment.

The term “pre-ceramic polymer” relates to a specialized polymer/oligomeric material which contain both organic and inorganic molecular segments and thermally decompose into (inorganic) ceramics when heated or subjected to high temperature treatments (pyrolysis).

In an embodiment of the present invention the inorganic segment is selected from the group consisting of aluminum oxide, silicon, silicon dioxide, titanium, titanium oxide, zirconium, zirconium oxide, the combination between silicon and nitrogen, and mixtures hereof.

In a further embodiment of the present invention the organic segment may be carbon or carbon containing organic compounds.

In yet an embodiment of the present invention the pre-ceramic polymer may be a polycarbosilane, in particular an allyl hydrido polycarbosilane.

The binder, and/or the porous ceramic body, according to the present invention may not comprise a mixture of potassium feldspar, kaolin and quartz.

The method according to the present invention may involve a further step that may further improve the production of the porous ceramic body. Hence, the present invention involves the further step of adding a cross-linker to the mixture of ceramic powder and binder. Preferably, the cross-linker may be added to the ceramic powder provided in step (i), before the ceramic powder is mixed with the binder in step (iii).

In an embodiment of the present invention the cross-linker may be a water insoluble peroxide. Preferably, the cross linker may be dicumyl peroxide.

The method according to the present invention may involve a further step that may further improve the production of the porous ceramic body. Hence, the present invention involves the further step of adding a solvent to the mixture of ceramic powder and binder. Preferably, the solvent may be added to the binder provided in step (ii), before the binder is mixed with the ceramic powder in step (iii).

In an embodiment of the present invention the solvent may be an organic solvent. Preferably, the solvent, the organic solvent, may be toluene, hexane, benzene, xylene, dimethylformaide or a combination hereof.

The method according to the present invention may involve a further step that may further improve the production of the porous ceramic body. Hence, the present invention involves the further step of adding a pore filler to the mixture of ceramic powder and binder. Preferably, the pore filler may be added to the binder provided in step (ii), before the binder is mixed with the ceramic powder in step (iii).

In an embodiment of the present invention, the pore filler may be selected from an organic substance that decompose during the heating in step (v).

In a further embodiment of the present invention, the ceramic composition provided in step (iii) may be a slurry of ceramic powder.

In an embodiment of the present invention the slurry of ceramic powder has a moisture content in the range of 5-95% (w/w) moisture, such as in the range of 15-90% (w/w) moisture, e.g. in the range of 25-85% (w/w) moisture, such as in the range of 50-80% (w/w) moisture, e.g. in the range of 60-78% (w/w) moisture, such as about 78% (w/w) moisture.

When the components making up the porous ceramic body have been mixed providing the ceramic composition may be subjected to vigorous mixing to improve dispersion of the ceramic powder grains in the ceramic composition, preferably the ceramic powder grains may be homogeneously dispersed in the ceramic composition by the vigorous mixing.

In an embodiment of the present invention the vigorous mixing of the ceramic composition may be provided by ultrasonic treatment of the ceramic composition or by vigorously shaking.

In another embodiment of the present invention the mixing provided in step (iii), e.g. the ultrasonic treatment, may be continued for at least 15 minutes, such as at least 30 minutes, e.g. at least 45 minutes, such as at least 1 hour, e.g. for at least 90 minute, such as at least 2 hours, e.g. for at least 150 minute, such as at least 3 hours, e.g. for at least 210 minute.

The ceramic composition according to the present invention, preferably in the form of a slurry, may be used for coating the porous support.

In an embodiment of the present invention the porous support may be in the form of a plate, a pipe. The pipe may be a round pipe, a triangular pipe, a square shaped pipe, a hexagonal shaped pipe, an octagonal shaped pipe or another kind of shaped pipe depending on the application of the porous ceramic body. The porous support may comprise an outside surface, an inside surface, and an internal cavity. Preferably, the outside surface, the inside surface or both the inside surface and the outside surface are coated with the ceramic composition. Preferably, the porous support may be coated on all sides with the porous ceramic body.

It may be important to ensure sufficient distribution of the powder composition during coating of the porous support and hence obtain an even and homogenous distribution of the pore size and porosity of the porous ceramic body.

In an embodiment of the present invention the porous support may be coated with the ceramic composition as described in step (iv) by dipping the porous support into the ceramic composition providing the ceramic coated porous support.

In another embodiment of the present invention the porous support may be coated with the ceramic composition as described in step (iv) by spraying the ceramic composition onto the porous support providing the ceramic coated porous support.

In a further embodiment of the present invention the porous support may be coated with the ceramic composition as described in step (iv) by pouring the ceramic composition onto the porous support providing the ceramic coated porous support.

When the powder composition has been coated on the porous support the coated ceramic body may be subjected to a drying step prior to heating. In an embodiment of the present invention the drying step involves subjecting the coated ceramic body to warm and/or dry air. In an embodiment of the present invention the ceramic coated porous support may be subjected to drying at a temperature below 100° C., such as a temperature below 75° C. e.g. a temperature below 50° C., such as a temperature in the range of 10-100° C., e.g. a temperature in the range of 25-75° C., such as a temperature in the range of 40-50° C. Depending on the thickness of the ceramic composition placed on the porous support, the humidity, the drying temperature of the ceramic coated porous support may be subjected to drying for a period of time in the range of ½-10 hours, e.g. a period of time in the range of 1-7 hours, such as for a period of time in the range of 2-5 hours.

In order to increase the thickness of the ceramic layer of the porous ceramic body, and/or to improve the homogenous distribution of the ceramic grains over the porous support and/or to improve the performance of the porous ceramic body the step of coating and drying the may be repeated. In an embodiment of the present invention the steps of coating the porous support with the ceramic composition and drying may be repeated at least 2 times, such as 3 times, e.g. 5 times.

The porous support where the ceramic composition has been coated on to may be of the same of a different ceramic source as the ceramic powder provided in step (i). Preferably, the ceramic source used for the porous support may be selected from the group consisting of aluminium, aluminium oxide, silicon, silicon oxide, titanium, titanium oxide, zirconium, zirconium oxide and mixtures hereof.

In a preferred embodiment of the present invention, ceramic source of the porous support may be a silicon carbide (SiC).

In yet an embodiment of the present invention the porous support may be a honeycomb plate or a honeycomb pipe, preferably, an extruded honeycomb plate or an extruded honeycomb pipe.

The porous support may preferably have a mean pore size which is significantly larger than the mean pore size of the porous ceramic body. In an embodiment of the present invention the mean pore size is at least 5 times larger than the mean pore size and/or the porosity of the porous ceramic body, such as at least 10 times larger, e.g. at least 25 times larger, such as at least 50 times larger, e.g. at least 75 times larger.

Preferably, the porous support has a pore size in the range of 1-15 μm, e.g. in the range of 1.5-8 μm, such as in the range of 2-5 μm, e.g. in the range of 2.5-4 μm, e.g. about 3 μm. Furthermore, the porous support may, preferably, have a porosity in the range of 25-75%, e.g. in the range of 30-65%, such as in the of 35-55%, e.g. in the range of 40-45%.

Depending on e.g. the mean grain size of the ceramic powders in the powder composition and/or the thickness of the ceramic composition on the porous support, the exact heating time and temperature may be determined in a case by case basis.

In an embodiment of the present invention the heating time and the temperature for providing a given porous ceramic body according to the present invention may be when the ceramic grains in the ceramic composition are united into a single coherent structure of a porous ceramic body having a uniform and homogeneously distributed porosity with continuous substantially equally sized pores in a three-dimensional pore network.

In order to provide the united single coherent structure of a porous ceramic body, the ceramic coated porous support is heated. Preferably, the heating in step (v) is provided by transferring the ceramic coated porous support into a furnace.

In an embodiment of the present invention the heating of the coated porous support in step (v) is provided by sintering of the coated support.

In another embodiment of the present invention the ceramic coated porous support is heated to a temperature (a heating temperature) between 500° C. and 1500° C. producing the porous ceramic body, such as a temperature between 550° C. and 1400° C., e.g. a temperature between 600° C. and 1300° C., such as a temperature between 650° C. and 1200° C., e.g. a temperature between 700° C. and 1100° C., such as a temperature between 750° C. and 1000° C., e.g. a temperature between 800° C. and 900° C., such as about 800° C.

In order to increase the safety when heating the ceramic coated porous support, the air surrounding the ceramic coated porous support may be removed, or substituted, during heating in step (v) before heating of the ceramic coated porous support. In alternative to the presence of oxygen during the heating, may be provided, e.g. intro the furnace. In an embodiment of the present invention the air surrounding the ceramic coated porous support during the heating in step (v) is substituted with one or more inert gas/gases, preferably, helium, nitrogen, or argon. Preferably, the oxygen may be evacuated by vacuum.

In an embodiment of the present invention the time for heating the ceramic coated porous support at the heating temperature is less than 12 hours, such as less than 9 hours, e.g. less than 6 hours, such as less than 5 hours, e.g. less than 4 hours, such as less than 3 hours, e.g. less than 2.5 hours, such as less than 2 hours.

In the present context, the term “time for heating” means the time the heating in step (v) is kept at the heating temperature, meaning that the time for raising the temperature from starting temperature of the coated ceramic porous support to the heating temperature and the subsequent cooling time is not included.

In a further embodiment of the present invention the heating rate of the heating in step (v) may be in the range of 30-300° C./hour, such as in the range of 50-250° C./hour, e.g. in the range of 70-200° C./hour, such as in the range of 80-150° C./hour, e.g. in the range of 90-125° C./hour, about 100° C./hour.

In the present contest the term “heating rate” relates to the speed by which the temperature is increased from a starting temperature to a heating temperature, determined in ° C./hour.

In a further embodiment of the present invention the cooling rate of the porous ceramic body when the heating in step (v) has completed may be in the range of 30-300° C./hour, such as in the range of 50-250° C./hour, e.g. in the range of 70-200° C./hour, such as in the range of 80-150° C./hour, e.g. in the range of 90-125° C./hour, about 100° C./hour.

In the present contest the term “cooling rate” relates to the speed by which the temperature is reduced from a heating temperature to a temperature ready for further treatment/handling, determined in ° C./hour.

Following heating of the coated ceramic porous support resulting in the porous ceramic body, the porous ceramic body may be oxidized in order to improve performance and strength of the porous ceramic body.

Hence, in an embodiment of the present invention the porous ceramic body obtained in step (v) may be subjected to a step of oxidization. Preferably, the oxidization may be performed in the presence of air at a temperature in the range of 800° C. and 1400° C., e.g. a temperature between 900° C. and 1200° C., such as a temperature between 950° C. and 1100° C., e.g. a temperature between 1000° C. and 1050° C.

In a further embodiment of the present invention the heating rate of the oxidization step may be in the range of 100-300° C./hour, such as in the range of 150-250° C./hour, e.g. about 200° C./hour.

The method according to the present invention and as defined above may result in a unique porous ceramic body with unique applications and/or unique characteristics compared to the porous ceramic bodies described in the prior art.

A preferred embodiment of the present invention relates to a porous ceramic body comprising crystal-like ceramic grains.

In the context of the present invention, the term “crystal-like” relates to ceramic grains where the atoms are arranged in a highly ordered microscopic structure, forming a crystal lattice that extends in all directions. The crystal-like structure of the ceramic grains according to the present invention may be identifiable by the special geometrical shape, comprising of flat faces with specific, characteristic orientations.

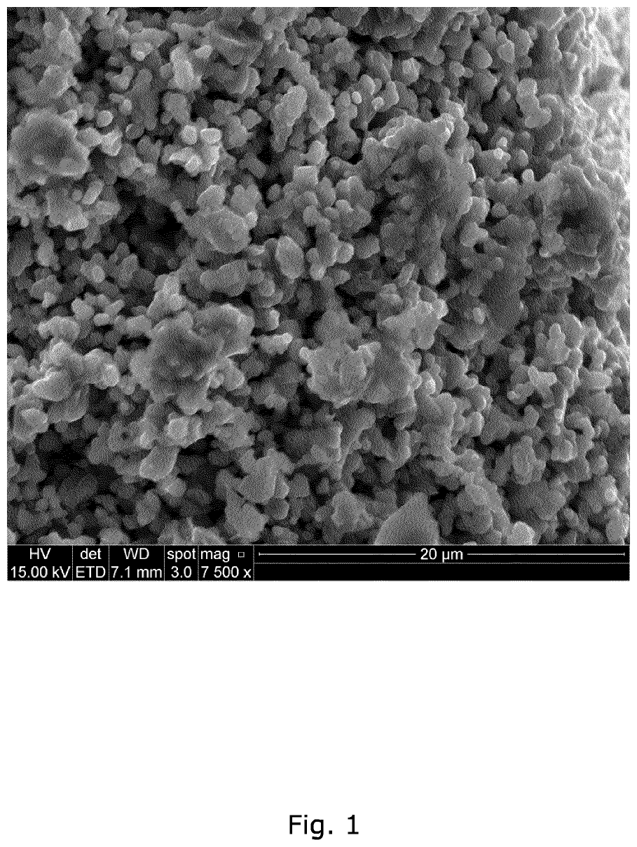

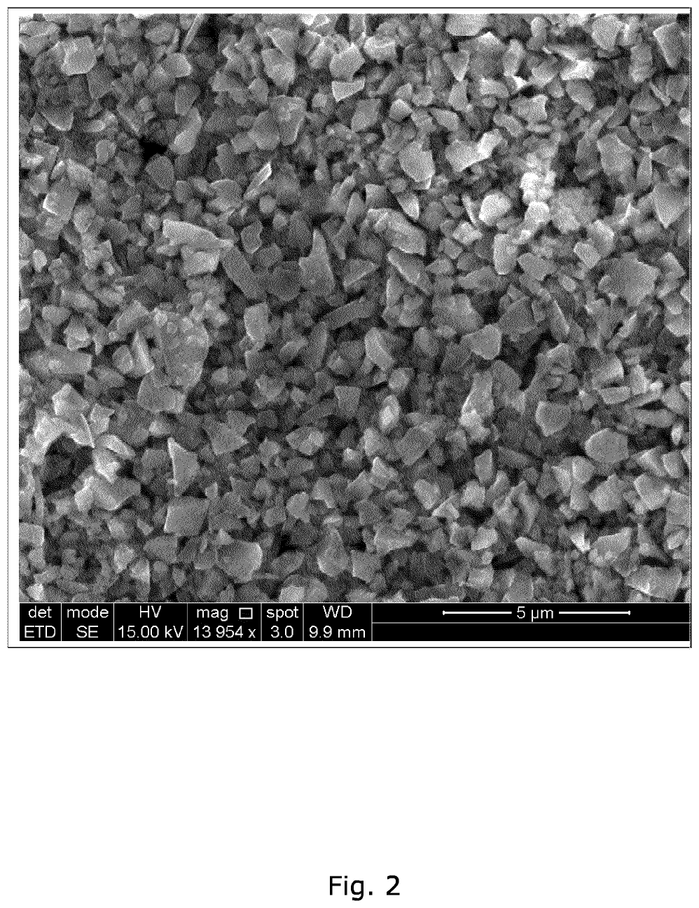

Without being bound by any theory, it is believed that due to the lower heating temperature of the present invention, relative to the heating temperatures described in the prior art, an insignificant portion of the surface of the individual ceramic grains are melted and more of the original crystal structure of the ceramic grains are maintained (see FIG. 2). Whereas, the prior art processes, using higher temperatures and longer heating times results in a significantly larger part of the surface of the ceramic grains are melted, more grains are fused together and much less of the original crystal structure are maintained (see FIG. 1).

In an embodiment of the present invention the porous ceramic body may have a mean pore size in the range of 0.04-2 μm, e.g. in the range of 0.075-1.5 μm, such as in the range of 0.1-1 μm, e.g. in the range of 0.15-0.5 μm, e.g. in the range of 0.2-0.3 μm, e.g. in the range of 0.2-0.25 μm.

The porous ceramic body may preferably have a porosity in the range of 25-75%, e.g. in the range of 30-65%, such as in the of 35-55%, e.g. in the range of 40-45%.

Furthermore, the porous ceramic body may have a water permeability above 500 LMHB (LMHB relates to volume per area per time per pressure; measured as Ltr/(m²×hr×bar)), such as above 750 LMHB, e.g. above 1000 LMHB, such as above 1200 LMHB, e.g. in the range of 500-5000 LMHB, such as in the range of 750-4000 LMHB, e.g. in the range of 1000-3500 LMHB, such as in the range of 1500-3000 LMHB, e.g. in the range of 2000-2500 LMHB.

In an embodiment of the present invention, the porous ceramic body comprises at least 95% (w/w) ceramic material, such as SiC; e.g. at least 96% (w/w); such as at least 97% (w/w); e.g. at least 98% (w/w); such as at least 99% (w/w); e.g. at least 99.2% (w/w); such as at least 99.5% (w/w); e.g. at least 99.7% (w/w); such as at least 99.9% (w/w).

The average grain size of the ceramic grains of the porous ceramic body may be below 50 μm, such as below 40 μm, e.g. below 30 μm, such as below 20 μm, e.g. below 10 μm, such as below 5 μm, e.g. below 3 μm, such as below 2 μm, e.g. below 1 μm, such as below 0.75 μm, e.g. below 0.5 μm.

In an embodiment of the present invention the crystal-like ceramic grains may not be melted together. In this respect, the bond attaching the individual ceramic grains does not come from the ceramic powder. Preferably, the bond attaching the individual ceramic grains may be provided from the binder according to the present invention, such as a pre-ceramic polymer.

The composition according to the present invention or the ceramic composition according to the present invention may further comprise a de-foaming agent. In the present context, the term “de-foaming agent” relates to a component capable of avoid foaming of the slurry comprising the powder composition when subjected to heating, which may result in cracks in the porous ceramic body provided.

Moreover, the composition according to the present invention or the ceramic composition according to the present invention may further comprise a de-flocculating agent. In the context of the present invention the term “de-flocculating agent” relates to a component capable of keeping the solids of the slurry comprising the powder composition in suspension and to ensure a homogenous distribution of the grains. In an embodiment of the present invention the de-flocculating agent” may be selected from the group consisting of glycol, silicones, insoluble oils and combinations hereof.

In order to provide the porous ceramic body according to the present invention, a unique composition may be provided comprising the binder in order to provide a stable, strong and suitable porous ceramic body.

Hence, a preferred embodiment of the present invention relates to a composition comprising a binder, a solvent and a pore filler, wherein the binder comprises a pre-ceramic polymer.

The composition may subsequently be mixed with a ceramic powder, or in an embodiment of the present invention the composition further comprises a ceramic powder.

Furthermore, the composition may further comprise a cross-linker.

The porous ceramic body may be used for different purposes such as a cross-flow membrane, a dead-end membrane, a tubular membrane or a flat sheet membrane. In respect of the tubular membrane or the flat sheet membrane water to be purified may run on either the inside of the membrane and excreting the permeate to the outside or the water to be purified may run on the outside and excreting the permeate to the inside.

In a preferred embodiment of the present invention, the porous ceramic body may be a flat sheet membrane and/or the porous ceramic body is an outside-in filtration ceramic membrane.

In an embodiment of the present invention the method may be a one-step process. Preferably, the one-step process does not involve a layer-wide repeating of various ceramic powders with decreasing mean grain sizes including repeated heating steps.

In an embodiment of the present invention, the porous ceramic body and/or the membrane filter according to the present invention may be an ultrafiltration unit or a microfiltration unit.

Preferably the porous ceramic body obtainable by a method according to the present invention or a porous ceramic body according to the present invention may preferably be used in microfiltration or in ultrafiltration.

As mentioned above a further aspect of the present invention relates to a submersible system comprising a porous ceramic body according to the present invention and/or a membrane filter unit according to the present invention.

Preferably the submersible system according to the present invention, further comprising a vacuum pump. Said vacuum pump may be used for creating a negative pressure forcing the water to be purified to enter the filter and/or the porous ceramic body from the outside allowing the permeate to exit the filter and/or the porous ceramic body from the inside.

Alternatively, the submersible system may be submerged into a pressurized tank. In such pressurized tank a pressure is applied to the water tank forcing the water to enter the water to be purified to enter the filter and/or the porous ceramic body from the outside allowing the permeate to exit the filter and/or the porous ceramic body from the inside.

In an embodiment of the present invention, the submersible system comprises two or more porous ceramic bodies according to the present invention, such as 3 or more, e.g. 4 or more, such as 5 or more, e.g. 7 or more, such as 10 or more, e.g. 15 or more, such as or more, e.g. 30 or more.

The porous ceramic body, the membrane filter, and/or the submersible system according the present invention may be suitable for water purification.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1

This example illustrates one way of providing an porous ceramic body in form of an ultrafiltration membrane as described in the prior art using high temperature treatment. The method used the following procedure:

A ceramic composition is provided comprising fine SiC having a mean grain size in the range of 0.1-0.7 μm and coarse SiC having a mean grain size in the range of 0.3-1.1 μm.

The ceramic composition is mixed with ethylene glycol, which act as a water soluble polymeric binder, in a mass ratio of approximately 7:1 (ceramic composition:binder) and is stirred for about 24 hours.

A porous support, comprising SiC, is coated with the stirred ceramic composition by:
a. Dip coating the porous support into the stirred ceramic substrates;
b. Dry the coated porous support in a heated and ventilated chamber at 50-60° C. for 2-5 hours;
c. The dip coating in step (a) was repeated; and
d. The drying in step b was repeated.

The coated porous support is then placed in a furnace and heated/sintered in the presence of argon at a temperature of 1700-1900° C. The time for heating was continued for 3-5 hours at the at the maximum heating temperature.

When sintering is finished the sintered porous support is allowed to cool whereby the sintered porous support is subjected to an oxidizing treatment where the sintered porous support is heated to 1000-1050° C. in the presence of air for 30 minutes to remove non-bound or non-sintered material from the porous support.

The surface of the resulting ultrafiltration membrane is demonstrated in FIG. 1 and shows a SEM picture of the porous ceramic body provided according to example 1. From FIG. 1 it is clear that the prior art process results in a significantly larger part of the surface of the ceramic grains are melted, more grains are fused together and much less of the original crystal structure are maintained and the mean pore size becomes larger.

The ultrafiltration membrane showed to have a porosity in the range of 40-45% and a mean pore size in the range of 0.5-0.6 μm, and a water permeability in the range of 3.000-10.000 LMHB.

### Example 2

This example has been provide to show one non-limiting example of providing a porous ceramic body in form of an ultrafiltration membrane according to the present invention using low temperature and reduced heating/sintering time. The method used the following procedure:

A ceramic composition is provided comprising a coarse SiC composition having a mean grain size in the range of 0.6-1.1 μm. The ceramic composition is mixed with Allyl hydrido polycarbosilane, which act as a water insoluble binder, in a mass ratio of approximately 10:1 (ceramic composition:binder) and is stirred for about 5 hours.

A porous support, comprising SiC, is coated with the stirred ceramic composition by:
a. Dip coating the porous support into the stirred ceramic substrates;
b. Dry the coated porous support in a heated and ventilated chamber at 50-60° C. for 2-5 hours;
c. The dip coating in step (a) was repeated; and
d. The drying in step b was repeated.

The coated porous support is then placed in a furnace and heated/sintered in the presence of argon at a temperature of 750-800° C. The time for heating was continued for 2 hours at the at the maximum heating temperature.

When sintering is finished the sintered porous support is allowed to cool whereby the sintered porous support is subjected to an oxidizing treatment where the sintered porous support is heated to 1000-1050° C. in the presence of air for 30 minutes to remove non-bound or non-sintered material from the porous support.

The resulting ultrafiltration membrane is demonstrated in FIG. 2 and shows a SEM picture of the porous ceramic body provided according to example 2. From FIG. 2 it is clear that non, or an insignificant portion of the surface, of the individual ceramic grains are melted and more of the original crystal structure of the ceramic grains are maintained. Without being bound by any theory, it is believed that due to the lower heating temperature of the present invention, relative to the heating temperatures described in the prior art, the particles do not melt and substantially maintains the crystal structure.

The ultrafiltration membrane showed to have a porosity in the range of 40-45% and a mean pore size in the range of 0.2-0.25 μm, and a water permeability in the range of 2.000-2.500 LMHB.

The lower water permeability of the ultrafiltration membrane provided in example 2 relative to the ultrafiltration membrane provided in example 1 is due to the smaller mean pore provided in the ultrafiltration membrane provided in example 2 relative to the mean pore size of the ultrafiltration membrane provided in example 1.

### REFERENCES

EP 3 009 182
U.S. Pat. No. 7,699,903

1-14. (canceled)

15. A method for production of a porous ceramic body for a membrane filter, the method comprises the following steps:
(i) selecting a ceramic powder;
(ii) selecting a binder comprising a pre-ceramic polymer;
(iii) mixing the ceramic powder from step (i) with the binder from step (ii) providing a ceramic composition;
(iv) coating a porous support with the ceramic composition providing a ceramic coated porous support;
(v) heating the ceramic coated porous support to a temperature between 500° C.-1500° C. producing the porous ceramic body,
wherein the porous ceramic body obtained in step (v) is subjected to a step of oxidization.

16. The method according to claim 15, wherein an organic solvent is added to the binder selected in step (ii).

17. The method according to claim 15, wherein the air surrounding the ceramic coated porous support during the heating in step (v) is substituted with one or more inert gas/gases, preferably, nitrogen or argon.

18. The method according to the present invention, wherein the oxidization is performed in presence of air at a temperature in the range of 800° C. and 1400° C., e.g. a temperature in the range 900° C. and 1200° C., such as a temperature in the range 950° C. and 1100° C., e.g. a temperature in the range 1000° C. and 1050° C.

19. A method according to claim 15, wherein the porous ceramic body is a microfiltration membrane or an ultrafiltration membrane.

20. A porous ceramic body obtainable by a method according to claim 15.

21. A porous ceramic body according to claim 20 comprising crystal-like ceramic grains.

22. The porous ceramic body according to claim 20, wherein the porous ceramic body is a porous liquid ceramic body.

23. The porous ceramic body according to claim 20, wherein the porous ceramic body, or the porous liquid ceramic body is a porous water ceramic body.

24. The porous ceramic body according to claim 20, wherein the porous ceramic body has a mean pore size in the range of 0.04-2 μm.

25. The porous ceramic body according to claim 20, wherein the porous ceramic body does not comprise a mixture of potassium feldspar, kaolin and quartz

26. The porous ceramic body according to claim 20, wherein the porous ceramic body has a porosity in the range of 25-75%, e.g. in the range of 30-65%, such as in the of 35-55%, e.g. in the range of 40-45%.

27. The porous ceramic body according to claim 20, wherein the crystal-like ceramic grains are not melted together.

28. Use of the porous ceramic body according to claim 20, in a microfiltration or an ultrafiltration.

29. The method according to claim 16, wherein the air surrounding the ceramic coated porous support during the heating in step (v) is substituted with one or more inert gas/gases, preferably, nitrogen or argon.

30. A method according to claim 16, wherein the porous ceramic body is a microfiltration membrane or an ultrafiltration membrane.

31. A method according to claim 17, wherein the porous ceramic body is a microfiltration membrane or an ultrafiltration membrane.

32. A method according to claim 18, wherein the porous ceramic body is a microfiltration membrane or an ultrafiltration membrane.

33. A porous ceramic body obtainable by a method according to claim 16.

34. A porous ceramic body obtainable by a method according to claim 17.
